(19) United States
(12) Patent Application Publication
(10) Pub. No.: US 2008/0193743 A1
(43) Pub. Date: Aug. 14, 2008

(54) Corrosion Control Coating Composition For Metal Workpieces and Method of Producing Same

(76) Inventors: Thomas Kruse, Dortmund (DE); Heike Mertens, Hagen (DE); Gerhard Reusmann, Essen (DE)

Correspondence Address: BACHMAN & LAPOINTE, P.C., 900 CHAPEL STREET, SUITE 1201, NEW HAVEN, CT, 06510, US

(21) Appl. No.: 11/632,628

(22) PCT Filed: Jul. 7, 2005
(86) PCT No.: PCT/EP05/07360

§ 371 Date: Oct. 22, 2007

(30) Foreign Application Priority Data
Jul. 16, 2004 (DE) 10 2004 034 645.3

(51) Int. Cl. C23F 11/00; B32B 27/00; B05D 1/36; B05D 3/02; B05D 3/00

(52) U.S. Cl. 428/332; 252/389.31; 428/421; 427/407.1; 427/387; 427/299

(57) ABSTRACT

The invention relates to an anti-corrosive coating agent for metal workpieces. For the purpose of good cathodic corrosion prevention, the anti-corrosive coating agent comprises an organic binder having a silicon-organic compound and particulate metal. The workpiece having an anti-corrosive coating is characterized in that the anti-corrosive coating comprises an organic binder having a silicon-organic compound and particulate metal. The method for producing an anti-corrosive coating on a workpiece is characterized by applying, in liquid form, a first coating, comprising an organic binder having a silicon-organic compound and particulate metal as the anti-corrosive coating, and then applying a second coating the composition of which preferably differs from that of the anti-corrosive coating.

The invention relates to a corrosion control coating composition for metal workpieces and metallic materials, to a workpiece with corrosion control coating, and to a method for producing a corrosion control coating on a workpiece.

Corrosion control coatings and coating compositions are general knowledge in the art. By way of example U.S. Pat. No. 5,334,631 describes an anticorrosive powder consisting of a resin, a curing agent, and zinc in particle form. To apply a corrosion control coating with this coating composition, the workpiece is first heated to 240° C. Then the coating is applied in an electrostatic method in a thickness of 50 μm. Thereafter a further topcoat, composed of a polyester resin, is applied. The resulting coats are then cured at 180° C. A disadvantage with this method is that the conductivity and hence the effectiveness of the corrosion control are not optimally implemented.

EP 0 939 111 describes a coating for metallic workpieces that acts in particular to counter hydrogen embrittlement of the workpiece. The coating is composed of an epoxy resin, zinc dust, and a powder which expands under the effect of temperature. An optional ingredient is an adhesion promoter of a silane-epoxide type. The purpose of the expanding powder is to increase the effective area of the zinc dust. The coating applied to the workpiece is subsequently provided with a topcoat. A disadvantage with this coating, however, is that sufficient mechanical flexibility after application is not ensured.

It is an object, therefore, to provide a corrosion control coating composition for metal workpieces, a workpiece with corrosion control coating composition, and a method of producing a corrosion control coating on a workpiece that affords effective cathodic corrosion control.

In accordance with the invention this object is achieved by virtue of a corrosion control coating composition for metal workpieces, comprising
an organic binder with an organosilicon compound and
a particulate metal.

A workpiece with corrosion control coating comprises at least
an organic binder with an organosilicon compound and
a particulate metal.

In a method of producing a corrosion control coating on a workpiece in accordance with the invention
an initial coating comprising an organic binder with an organosilicon compound and a particulate metal is applied in liquid form as corrosion control coating, and
subsequently a second coating is applied whose composition is preferably different from the corrosion control coating.

Materials suitable for use as the organic binder include in particular those which crosslink even at very low temperatures and subsequently form a corresponding mechanically and chemically robust coating. Binders which can be used include, for example, epoxy compounds, but also polyesters and acrylates. By organosilicon compounds are meant those compounds which have Si—R bonds, R being an organo group. Preference is given to the organosilicon compound of the type Si—O—Si (siloxane). Organosilicon compounds of this kind form copolymers with typical organic binders, forming readily adhering and elastic coatings on metallic surfaces.

The particulate metal used ought preferably to be readily miscible with the binder, and ought to have a conductivity suitable for the establishment of a very high level of cathodic corrosion control, and the particulate metal ought to be suitable for forming a uniform coating. Examples of those suitable include zinc, aluminum, tin, manganese or alloys of said metals. Additions of conductive fillers are likewise possible.

Advantageously the coating composition is liquid on application. This makes it possible to apply a uniform coat in a simple way with known application methods. During transport and storage, however, the corrosion control coating composition may well be in a concentrated, pasty to solid form, not least in order to minimize the transport and storage costs.

In one development of the invention the binder is an acrylate, a polyester or a resin, in particular an epoxy resin, or a combination of these, with an organosilicon compound. Corresponding substances and combinations of substances are known in the art. Epoxy resins in particular possess very good properties in terms of mechanical and chemical robustness, which are required in the context of corrosion control coatings.

The organosilicon compound preferably comprises a polyorganosiloxane. Substances of this kind, particularly in conjunction with epoxy resins, are advantageous for the formation of a readily adhering and corrosion-resistant coating. Furthermore, these inorganic/organic binders effectively bind-in metal particles.

In accordance with a development of the invention the binder is a polyorganosiloxane resin, in particular a silicone-modified epoxy resin. Resins of this kind are available industrially, as for example in SILRES EP7 from Wacker Chemie or in SILIKOFTAL EW7 from Degussa. Preference extends to methylphenylsilicone, phenylsilicone, and methylsilicone resins. Also suitable are resins with vinyl or allyl groups, acrylic esters, ethyleneimino groups, halogenated phenyl radicals, fluorine derivatives, hydroxyorgano groups, carboxyorgano groups, aminoalkyl groups, siloxane-silazane copolymers, phenylene groups, or with cocondensation products with organic resins. An advantage of silicone-modified epoxy resins is that such resins combine the binding of a high proportion of particulate metal with high flexibility in a coating produced with this coating composition. The flexibility of the coating is sufficient so that when spring steel workpieces, such as chassis springs, for example, are coated, the coating does not flake off even under high mechanical loads.

The particulate metal is advantageously zinc. Aluminum, tin, manganese, and alloys of these are also suitable. In the context of this invention, particulate metal is understood as metal that is employed in small pieces, preferably in the form of spherical particles, especially dust, and/or lamellar particles, especially flakes. Zinc and the other aforementioned metals possess good conductivity and afford effective cathodic corrosion control. Also conceivable, of course, is the use of further metals. Corresponding coatings based on zinc and/or the other stated metals protect the metallic substrate against corrosion by virtue of the fact that these materials go into solution anodically, while the metallic substrate becomes the cathode. This mechanism protects the substrate against decomposition phenomena. The use of dust and flakes is an advantage on account of the relatively large surface area they have. Flakes offer the advantage, moreover, that it is possible to form thin coats in which the contact between the particles that is necessary for effective corrosion control is formed reliably. It should, however, be ensured that the flakes or the dust are sufficiently fine to allow the development of an adequately smooth and thin coating of 1 μm, 5 μm, 10 μm or more.

According to one development of the invention it is preferred for the binder in as-supplied form to form a fraction of 10-35 percent by weight of the coating composition, with particular preference 14-24 percent by weight. With relatively small fractions of binder, therefore, it is possible to build up an effective cathodic corrosion control coating. In as-supplied form the binder preferably has a solids content of 49%-55%. Depending on the requirements of the application, however, this figure can be varied within a wide range. It is also possible to use cobinders, especially organic cobinders, such as acrylate binders, polyvinylidene fluoride or other fluorinated polymers, whether in order specifically to adjust properties of the coating composition, or for reasons of cost.

It is also advantageous for the metal to form a fraction of 10-90 percent by weight of the coating composition in as-supplied form, preferably 35-85 percent by weight, with particular preference 45-70 percent by weight. Tests have shown that coating compositions of this kind afford a particularly high level of cathodic corrosion control. All in all it is regarded as advantageous that binder and particulate metal can be varied within a broad range depending on the requirements of the application. In principle, however, it is preferable for a very high fraction of metallic particles to be incorporated in the coating composition.

Advantageously the coating composition comprises one or more of the following components: crosslinking agents, adhesion promoters, additives, thickeners, catalysts, fillers, corrosion inhibitors, anticorrosion pigments, color pigments, and solvents, especially organic solvents. By adding crosslinking agents it is possible—if desired or necessary—to provide a completely cured coating. Adhesion promoters can be used if the substrate is difficult to coat. Fundamentally, however, it should be noted that the corrosion control coating composition of claim 1 possesses per se an excellent adhesion to metallic substrates. Additives and thickeners can be added if the viscosity or rheology of the coating composition is to be adjusted, or if the application properties of the product have to be adjusted. Catalysts serve to control the reaction behavior, particularly the reaction rates. Active and passive fillers are added in order to enhance the mechanical and thermal properties of the coating; for example, aluminum silicates, magnesium silicates, mica pigments, graphite, and molybdenum sulfide can be used. In particularly corrosive environments, corrosion inhibitors or anticorrosion pigments can be added. In this context, however, it should be noted that the corrosion control coating composition of claim 1 affords per se a sufficient cathodic corrosion control. Pigments serve for coloring. Solvents and liquid additives can be used in order to adjust the processing properties (sprayability).

Said corrosion control coating composition is notable according to one advantageous configuration for the fact that it undergoes preliminary crosslinking in a broad temperature range, preferably at temperatures from 50° C. to 300° C., with particular preference at low temperatures from 80° C. to 150° C. It is therefore suitable for use in particular with those metallic workpieces which on account of their physical properties cannot be subjected to any great heat. A typical example of this is the coating of spring steels, which after being shaped experience an unwanted change in microstructure if they are heated at above 160° C. for a prolonged time. The invention, though, is equally suitable for use with all other metallic materials as well. Preliminary crosslinking at low temperatures has an advantageous effect there because less energy than usual need be expended in order to fix the coating. A further result is a good compromise between the temperature and the time required for fixing.

In accordance with the invention a workpiece with corrosion control coating comprises at least one organic binder with an organosilicon compound and a particulate metal. The coated workpiece can be used with just this coating. It is also suitable, however, where appropriate following application of an adhesion promoter, to be provided with further coatings, examples being color-imparting paint systems or paint systems which afford further-improved chemical and/or mechanical protection or improved weathering resistance.

The applied coating preferably has a dry film thickness of 1-50 μm, more preferably 15-30 μm. Such a low coat thickness results in a coating of improved flexibility. In the case of a coating on spring materials, for example, it is possible in this way to prevent the coating flaking off.

Advantageously the workpiece has been pretreated prior to coating. A pretreatment further improves the adhesion of the coating and the corrosion control. The pretreatment should be adapted to the material. Pretreatment methods are known in the art. With preference the pretreatment is carried out by means of blast cleaning. These methods remove contaminants and also any surface rust from the workpiece. In particular, scale on the surface of the material is deleterious to corrosion control and is typically removed by blast cleaning. The pretreatment ought to take place in such a way that, following pretreatment, there is no damage to the material and there are no residues of any cleaning agent used on the surface of the workpiece.

In a development of the invention the workpiece has at least one further coating which has been applied to corrosion control coating and comprises one or more of the following components: thermoplastic polycondensates, especially polysulfone (PSU), polyphenylenesulfide (PPS), polyphenyl ether sulfone (PPSU), polyether sulfone (PES), polyaryl ether ketone (PAEK), polyether ketone (PEK), polyamide (PA), poly-(amide-imide) (PAI), poly(ether-imide) (PEI), poly-(imide-sulfone) (PISO), and polyether ether ketone (PEEK), and also fluorinated polymers, especially polytetrafluoroethylene (PTFE), polyvinylidene fluoride (PVDF), tetrafluoroethylene/hexafluoropropylene copolymer (FEP), perfluoroalkoxy copolymer (PFA), copolymer of tetrafluoroethylene with perfluorinated propylene and perfluoroalkyl vinyl ether (EPE), copolymer of tetrafluoroethylene and perfluoromethyl vinyl ether (MFA), copolymer of tetrafluoroethylene with ethylene (ETFE), polychlorotrifluoroethylene (PCTFE), and copolymer of ethylene and chlorotrifluoroethylene (ECTFE), and phenolic resin-based thermosets. Further coatings of this kind serve as topcoats advantageously for the protection of the corrosion control coating against chemical and mechanical damage and also against effects of weathering. Where appropriate they may also serve for coloring. For instance, in the automobile segment, for example, these further coatings should be designed such that the corrosion control coating is protected, for example, against stonechipping and effects of weathering.

Preferably at least one further coating, in particular a topcoat, preferably a powder coating, is applied to the fixed corrosion control coating, in particular the corrosion control coating which has undergone preliminary crosslinking. Coatings of this kind are, advantageously, available industrially, and protect the corrosion control coating against mechanical, chemical, and weather effects. Suitable powder coating materials here are all commercial powder coating materials, examples being epoxy, polyester, polyamide, polyurethane, and acrylate powder coating materials, and also hybrid powder coating materials.

In accordance with the invention, in a method of producing a corrosion control coating on a workpiece, a first coating comprising an organic binder with an organosilicon compound and a particulate metal is applied in liquid form as a corrosion control coating. Subsequently a second coating is applied whose composition is preferably different from that of the corrosion control coating. Since the second coat no longer serves for cathodic corrosion control, this coat can be designed advantageously to reinforce the workpiece against further stresses (chemical, mechanical loads, weathering) and/or may serve decorative purposes.

Preferably the second coating is applied as a powder coating. As already mentioned, powder coating materials are advantageously available industrially. Those suitable include all commercially customary powder coating materials, examples being epoxy, polyester, polyamide, polyurethane, and acrylate powder coating materials, but also hybrid powder coating materials. They provide the coat beneath with sufficient protection against damage and external influences. Furthermore, the abovementioned thermoplastic polycondensates, fluorinated polymers, or phenolic resin-based thermosets are also suitable.

In a development of the invention the first coating is fixed after application but not completely cured. The term Afixed@ refers to all of those conditions which allow the application of the subsequent coats. The fixing of the initial coating ought to result in, first, sufficient adhesion to the substrate being ensured and, second, the application of a further coating being made possible. In particular, the breakdown of the first coat when further coats are applied ought not to be possible. Advantageously, the at least two-coat coating of the workpiece is completely cured only after the second coat has been applied, preferably after the final coat has been applied. The term Acompletely@ embraces all of those states in which the coats, with a view to the respective use of the workpiece, are serviceable or substantially completely crosslinked. This reduces the thermal load on the workpiece, which is an advantage in the context in particular of spring steel materials or similar materials. Curing ought to take place at a very low temperature and in a very short time.

According to one development of the invention the first coating is applied with a dry film thickness of 1-50 μm, preferably 15-30 μm. A very low and uniform dry film thickness further improves the flexibility of the coating.

The workpiece is advantageously pretreated prior to treatment. The pretreatment is preferably a blast cleaning treatment. As already mentioned earlier, an appropriately clean surface is advantageous for improved cathodic corrosion control. Likewise, however, it should also be ensured that there are no residues of any cleaning agent remaining on the surface to be coated, and that the workpiece is not damaged.

According to one development of the invention, after the first coating the applied coat is subjected to a temperature of 50° C.-300° C., preferably of 80° C.-150° C., and after the second coating the applied coats are subjected to a temperature of up to 400° C., preferably of 130° C.-240° C., with particular preference of 130° C.-160° C. Treating the first coat in this way ensures thermal fixing of the coating. The coating in this case is not completely crosslinked, but is suitable for application of a further coating. Following application of the second coat, the elevated temperature of up to 400° C., preferably of 130° C.-240° C., with particular preference of 130° C.-160° C., cures the coatings. A temperature of up to 400° C., however, is employed only in the case of special coatings and drying methods. In the case of temperature-sensitive workpieces it is necessary in general to use much lower temperatures. In conjunction with appropriate binders, the method can also be employed, advantageously, at low temperatures, thereby leaving the physical properties of heat-sensitive materials, such as spring materials, for example, unchanged. It is preferred for the workpiece to be heated to the aforementioned temperatures (substrate temperature). In principle, however, in the case for example of inductive heating, it is sufficient for the coating or, directly, the surface to be coated, rather than the whole workpiece, to be heated to this temperature.

The first coating is advantageously fixed within a period of at least 5 seconds, preferably within 15-90 minutes. In the case of inductive heating methods in particular, short periods of time are used, while in conventional heating methods fixing may well last for a number of hours. Advantageously, after the second coating has been applied the coats are cured for at least 10 seconds, preferably for 15-90 minutes.

The invention is now illustrated using an example.

For a corrosion control coating composition the following substances are first processed in a batch:

| | Weight percent of |
|---|---|
| Raw material | coating composition |
| Silicone-modified epoxy resin | 18% |
| solution (Silikoftal EW; Silres EP), | |
| liquid, solids content 48%-55% | |
| 1-Methoxy-2-propyl acetate; CAS No.: | 8% |
| 108-65-6 | |
| Silica, highly disperse, amorphous; | 1.6% |
| EINECS No.: 2315454 (Degussa, Wacker) | |
| Zinc dust, stabilized; CAS No,: 7440- | 56% |
| 66-6 | |
| Stapa zinc (Eckert-Werke) | 7% |
| 1-Methoxy-2-propyl acetate; CAS No.: | 3% |
| 108-65-6 | |
| Solvesso ^{R}150 (ExxonMobil); CAS No.: | 6.4% |
| 64742-94-5 | |
| Total: | 100% |

The abovementioned raw materials are dispersed in a dissolver at a temperature not exceeding 40° C. for 15-25 min. The coating composition can be applied to a workpiece using methods known in the art; by way of example, a coat can be applied in an HVLP (high volume low pressure) spraying method. The coating composition applied in liquid form to the workpiece subsequently undergoes preliminary crosslinking at a substrate temperature of 130° C. over a time of 30 minutes. Subsequently a commercially customary black epoxy resin powder coating material is applied to the fixed coating. The dry film thickness of this powder coating is 60-100 μm. The coated workpiece is then brought to a substrate temperature of 160° C.-200° C., whereby the two applied coats are jointly cured. This substrate temperature is maintained for 15-25 minutes.

1. A corrosion control coating composition for metal workpieces, comprising
an organic binder with an organosilicon compound and
a particulate metal.

2. The corrosion control coating composition for metal workpieces of claim 1, characterized in that the coating composition is liquid on application.

3. The corrosion control coating composition for metal workpieces of claim 1, characterized in that the organic binder is an acrylate, a polyester or a resin, or a combination of these with an organosilicon compound.

4. The corrosion control coating composition for metal workpieces of claim 1, characterized in that the organosilicon compound comprises a polyorganosiloxane.

5. The corrosion control coating composition for metal workpieces of claim 1, characterized in that the binder is a polyorganosiloxane resin.

6. The corrosion control coating composition for metal workpieces of claim 1, characterized in that the particulate metal is zinc, aluminum, tin, manganese or an alloy of these.

7. The corrosion control coating composition for metal workpieces of claim 1, characterized in that the binder in as-supplied form forms a fraction of 10-35 percent by weight of the coating composition.

8. The corrosion control coating composition for metal workpieces of claim 1, characterized in that the metal forms a fraction of 10-90 percent by weight of the coating composition in as-supplied form.

9. The corrosion control coating composition for metal workpieces of claim 1, characterized in that the coating composition comprises one or more of the following components:
crosslinking agents, adhesion promoters, additives, thickeners, catalysts, fillers, corrosion inhibitors, anticorrosion pigments, color pigments, and solvents, especially organic solvents.

10. The corrosion control coating composition for metal workpieces of claim 1, characterized in that the coating composition undergoes preliminary crosslinking in a temperature range from 50° C. to 300° C.

11. A workpiece with corrosion control coating at least comprising:
an organic binder with an organosilicon compound and
a particulate metal.

12. The workpiece with corrosion control coating of claim 11, characterized in that the applied coating has a dry film thickness of 1-50 μm.

13. The workpiece with corrosion control coating of claim 11, characterized in that the workpiece has been pretreated prior to coating.

14. The workpiece with corrosion control coating of claim 13, characterized in that the pretreatment has been carried out by means of blast cleaning.

15. The workpiece with corrosion control coating of claim 11, characterized in that at least one further coating has been applied to the fixed corrosion control coating, in particular the corrosion control coating which has been subjected to preliminary crosslinking, said further coating comprising one or more of the following components:
thermoplastic polycondensates, especially polysulfone (PSU), polyphenylenesulfide (PPS), polyphenyl ether sulfone (PPSU), polyether sulfone (PES), polyaryl ether ketone (PAEK), polyether ketone (PEK), polyamide (PA), poly(amide-imide) (PAI), poly(ether-imide) (PEI), poly(imide-sulfone) (PISO), and polyether ether ketone (PEEK), and also
fluorinated polymers, especially polytetrafluoroethylene (PTFE), polyvinylidene fluoride (PVDF), tetrafluoroethylene/hexafluoropropylene copolymer (FEP), perfluoroalkoxy copolymer (PFA), copolymer of tetrafluoroethylene with perfluorinated propylene and perfluoroalkyl vinyl ether (EPE), copolymer of tetrafluoroethylene and perfluoromethyl vinyl ether (MFA), copolymer of tetrafluoroethylene with ethylene (ETFE), polychlorotrifluoroethylene (PCTFE), and copolymer of ethylene and chlorotrifluoroethylene (ECTFE), and
phenolic resin-based thermosets.

16. The workpiece with corrosion control coating of claim 11, characterized in that at least one further coating has been applied to the fixed corrosion control coating.

17. A method of producing a corrosion control coating on a workpiece, in which
a first coating comprising an organic binder with an organosilicon compound and a particulate metal is applied in liquid form as a corrosion control coating, and
subsequently a second coating is applied whose composition is different from that of the corrosion control coating.

18. The method of producing a corrosion control coating on a workpiece of claim 17, characterized in that the second coating is applied as a powder coating material.

19. The method of producing a corrosion control coating on a workpiece of claim 17, characterized in that the first coating is fixed after application but not completely cured.

20. The method of producing a corrosion control coating on a workpiece of claim 17, characterized in that the at least two-coat coating of the workpiece is completely cured only after the second coat has been applied, preferably after the final coat has been applied.

21. The method of producing a corrosion control coating on a workpiece of claim 17, characterized in that the first coating is applied with a dry film thickness of 1-50 μm.

22. The method of producing a corrosion control coating on a workpiece of claim 17, characterized in that the workpiece is pretreated prior to coating.

23. The method of producing a corrosion control coating on a workpiece of claim 22, characterized in that the pretreatment is a blast cleaning treatment.

24. The method of producing a corrosion control coating on a workpiece of claim 17, characterized in that
after the first coating the applied coat is subjected to a temperature of 50° C.-300° C., and
after the second coating the applied coats are subjected to a temperature of up to 400° C.

25. The method of producing a corrosion control coating on a workpiece of claim 17, characterized in that the first coating is fixed within a period of at least 5 seconds.

26. The method of producing a corrosion control coating on a workpiece of claim 17, characterized in that after the second coating has been applied the coats are cured for at least 10 seconds.

27. The corrosion control coating composition for metal workpieces of claim 3, characterized in that the organic binder is an epoxy resin.

28. The corrosion control coating composition for metal workpieces of claim 5, wherein the binder is silicone modified epoxy resin.

29. The corrosion control coating composition for metal workpieces of claim 6, wherein the particulate metal is in the form of spherical particles and/or lamellar particles.

30. The corrosion control coating composition for metal workpieces of claim 7, wherein the binder in as-supplied form forms a fraction of 14-24 percent by weight of the coating composition.

31. The corrosion control coating composition for metal workpieces of claim 8, wherein the metal forms a fraction of 35-85 percent by weight of the coating composition in as-supplied form.

32. The corrosion control coating composition for metal workpieces of claim 8, wherein the metal forms a fraction of 45-70 percent by weight of the coating composition in as-supplied form.

33. The corrosion control coating composition for metal workpieces of claim 10, wherein the coating composition undergoes preliminary crosslinking in a temperature range from 80° C. to 150° C.

34. The corrosion control coating composition for metal workpieces of claim 12, wherein the coating has a dry film thickness of 15-30 μm.

35. The corrosion control coating composition for metal workpieces of claim 16, wherein the at least one further coating is a topcoat.

36. The corrosion control coating composition for metal workpieces of claim 16, wherein the at least one further coating is applied to the corrosion control coating which has undergone preliminary crosslinking.

37. The method of producing a corrosion control coating on a workpiece of claim 21, wherein the first coating is applied with a dry film thickness of 15-30 μm.

38. The method of producing a corrosion control coating on a workpiece of claim 24, wherein after the first coating, the applied coat is subjected to a temperature of 80° C.-150° C.

39. The method of producing a corrosion control coating on a workpiece of claim 24, wherein after the second coating the applied coats are subjected to a temperature of 130° C.-240° C.

40. The method of producing a corrosion control coating on a workpiece of claim 24, wherein after the second coating the applied coats are subjected to a temperature of 130° C.-160° C.

41. The method of producing a corrosion control coating on a workpiece of claim 25, wherein the first coating is fixed within a period of 15-90 minutes.

42. The method of producing a corrosion control coating on a workpiece of claim 26, wherein after the second coating has been applied the coats are cured for at least 15-90 minutes.
